(19) United States
(12) Patent Application Publication
(10) Pub. No.: US 2009/0004388 A1
(43) Pub. Date: Jan. 1, 2009

(54) Method for Depositing an Anti-Adhesion Layer

(76) Inventors: Franz Larmer, Weil Der Stadt (DE); Ralf Reichenbach, Esslingen (DE)

Correspondence Address: KENYON & KENYON LLP, ONE BROADWAY, NEW YORK, NY, 10004, US

(21) Appl. No.: 11/659,563

(22) PCT Filed: Jun. 21, 2005
(86) PCT No.: PCT/EP05/52862

§ 371 Date: Oct. 2, 2007

(30) Foreign Application Priority Data
Aug. 5, 2004 (DE) 10 2004 037 902.5

(51) Int. Cl. B05D 3/00

(52) U.S. Cl. 427/299

(57) ABSTRACT

A method for depositing an anti-adhesion layer onto a surface of micromechanical structures on a substrate. The material or precursor material to be deposited being delivered to the structures in a dissolution and transport medium. A supercritical CO₂ fluid is present as the dissolution and transport medium. Deposition of the material or precursor material is brought about by a change in the physical state of the CO₂ fluid or by a surface reaction between the surface and the precursor material. The method makes possible subsequent coating of the micromechanical structures in a cavity after encapsulation thereof, the material to be deposited being delivered via access channels or perforation holes.

### FIELD OF THE INVENTION

The present invention relates to a method for depositing an anti-adhesion layer onto surfaces of micromechanical structures on a substrate.

### BACKGROUND INFORMATION

When micromechanical structures are manufactured or used, for example in sensor components, the risk and problem exist that the movable structure may adhere or remain “stuck” to stationary regions of the component.

When movable structures are exposed in wet-chemical fashion, sticking of the movable structure to stationary regions of the component can occur when, after the movable structure is created by an etching technique, firstly the etching fluid is replaced with a rinsing fluid and then the component is dried. During this drying phase, the rinsing liquid progressively contracts between the free-standing structure and the stationary region of the component, e.g., the substrate surface beneath the structure, and the free-standing structure is pulled toward the stationary region of the component because of the surface tension or capillary action of the droplet of rinsing fluid. If they come into contact, they then (undesirably) stick together if the adhesive force acting between them is greater than the mechanical resilience of the free-standing structure.

To eliminate this problem, a drying operation is often performed in which no surface tension (or only a negligible amount) occurs. In so-called supercritical point drying, a liquid transition medium (usually CO₂), which surrounds the free-standing structures, is converted to the gas phase without crossing the liquid-gas phase boundary. Instead, the pressure and temperature of the CO₂ fluid are adjusted so that the liquid CO₂ fluid is first converted into a supercritical CO₂ fluid and then brought into the gaseous state. A supercritical fluid is, by definition, in a state with a temperature greater than or equal to its critical temperature, and a pressure greater than or equal to its critical pressure. The critical temperature and critical pressure for CO₂ are 30.98° C. and 74 bar (=7.4 MPa). Micromechanical structures are typically exposed by etching away a sacrificial layer, made of silicon dioxide, using hydrofluoric acid, then rinsing with water and acetone or isopropanol or other alcohols, and drying with a drying device referred to as a “supercritical point drier” (SCPD). In this conventional method the acetone can very easily be displaced by CO₂, whereupon, in the supercritical point drier, the CO₂ is converted first into the supercritical state and then into the gaseous phase, so that this process yields dry, movable structures. The use of such a process in a standard complementary metal oxide semiconductor (CMOS) environment is not unproblematic, however, since the structures and therefore the wafers must not dry out until they are dried in the supercritical point drier, since otherwise adhesion of the micromechanical structures already takes place in the meantime. In one widely used drier of a known company, the wafer is pressed for this purpose into a wafer basket under, for example, isopropanol. This permits supercritical drying but not evaporation of the alcohol. Certain handling difficulties nevertheless exist, especially in the context of a completely automated production process. Coating with an anti-adhesion layer is not provided for in this procedure.

German Patent Application No. DE 101 51 130 describes a method for manufacturing a micromechanical component having a movable structure, in which, to prevent sticking of the movable structure, the latter is partially immobilized with photoresist before the movable structure is etched out. In a supercritical point drier, the photoresist is removed with an organic solvent that is then displaced and dissolved using CO₂. Raising the temperature of the drier above the critical point of CO₂ dries the component without allowing sticking to occur. Deposition of an anti-adhesion layer is not, however, provided for. This method can therefore eliminate sticking while the movable structure is being manufactured (“release stiction”), but does not constitute a measure against adhesion of the structures during later use (“in-use stiction”).

One possible measure to prevent sticking of the structures during later use is deposition of an anti-adhesion layer onto the surface of the micromechanical structures. The anti-adhesion layer (“anti-stiction coating,” ASC) can be deposited onto the structures via a liquid-phase or gas-phase process.

For example, the document W. Ashurst et al., “Dichlorodimethylsilane as an Anti-Stiction Monolayer for MEMS: A Comparison to the Octadecyltrichlorosilane Self-Assembled Monolayer,” J. of MEMS, Vol. 10, No. 1, March 2001, pp. 41-49, describes a method for depositing an anti-adhesion layer that stipulates, as a solvent, isooctane having a precursor material for layer formation dissolved in it. In the aforementioned document, monolayers of dichlorodimethylsilane (DDMS) and monolayers of octadecyltrichlorosilane (OTS) are deposited, and their layer properties are compared to one another.

Other known alkylchlorosilanes constituting possible materials for an anti-adhesion layer are, for example, monochlorosilanes, perfluorooctadecyltrichlorosilanes, or tridecafluoro-x-tetrahydrooctyltrichlorosilanes, or alkylhalosilanes in general. Also used as materials for an anti-adhesion layer, however, are non-chlorine-containing dimethylaminosilanes, or alkenes such as, for example, 1-octadecenes. These materials react with the appropriately pretreated silicon surface of the micromechanical structures, and form thereon monolayers, i.e., single-molecule layers with a layer thickness of only a few angstroms. In addition, fullerenes and disilabutanes are also used to deposit high-temperature-resistant SiC monolayers onto micromechanical structures as anti-adhesion layers and so-called anti-wear coatings.

This kind of deposition from the liquid phase cannot, however, readily be integrated into the production procedure for certain micromechanical sensors or Microsystems. If, for example, encapsulation of the microsystem structure takes place by anodic bonding of an encapsulating wafer equipped with cavities, an anti-adhesion layer must not be present on the bonding surfaces. The existence of an anti-adhesion layer on the bonding surfaces considerably impairs the strength and durability of the anodic connection, and thus its reliability. In the case of encapsulation using a thin-layer encapsulation technology such as SUMICAP (surface micro-machined encapsulation on the wafer level), the anti-adhesion layer can once again result in incompatibility with subsequent layer deposition and structuring operations, and in contamination of the production facilities necessary for them. A further disadvantage of deposition from the liquid phase is the “release stiction” problem caused by capillary forces, already familiar from the manufacture of free-standing structures.

Alternatively, the material or precursor material to be deposited can also be delivered to the structures via a gas-phase process. For example, U.S. Application 2003/0099028 describes depositing an anti-adhesion layer using a plasma-enhanced chemical vapor deposition (PECVD) process. According to US 2003/0099028 A1, after the anti-adhesion layer has been deposited onto regions such as electrode surfaces that are to remain uncoated, the anti-adhesion layer is removed again by way of a separate and additionally necessary etching step. If, instead, deposition of the anti-adhesion layer is performed after encapsulation through access holes, called perforation holes, in the encapsulating layer, the general problem exists of non-conforming, i.e., non-uniform, deposition. The material of the anti-adhesion layer may possibly close off the access holes during deposition, before the anti-adhesion layer has been completely applied onto all the relevant micromechanical structures. It may be expected, in particular, that structure regions located lower down can no longer be adequately coated. Little mass transport is possible in general in the gas phase, so that only low deposition rates can be achieved. In addition, selection of the materials or precursor materials to be deposited is limited in the context of deposition from the gas phase.

Furthermore, when chlorine-containing materials are used, a general risk exists of the formation of hydrochloric acid (HCl), which can attack and corrode the production facility or metal contacts on the wafers, or can be the occasion for the occurrence of corrosion at a much later time.

### SUMMARY

An example method according to the present invention for depositing an anti-adhesion layer onto surfaces of micromechanical structures has the advantage that when the method is carried out, no sticking problems occur due to capillary forces of the dissolution, transport, or rinsing medium; and that it simultaneously makes possible conforming, i.e., uniform, deposition even through small channels or perforation holes.

The example method is thus also suitable for depositing an anti-adhesion layer, after encapsulation of the micromechanical structures, through access holes in the encapsulating layer.

Advantageous refinements of the example method according to the present invention are described in detail below.

### BRIEF DESCRIPTION OF THE DRAWINGS

Exemplary embodiments of the present invention are depicted in the figures and described in more detail below.

FIGS. 1 and 2 each show, in section, an example of a micromechanical structure on a substrate, on which deposition of an anti-adhesion layer can be carried out.

### DETAILED DESCRIPTION OF EXAMPLE EMBODIMENTS

According to an example embodiment of the present invention, the material or precursor material to be deposited is delivered to the structures using supercritical CO₂ fluid as a dissolution and transport medium. Deposition is brought about either by a change in the physical state of the CO₂ fluid, or by a surface reaction between the surface of the structures and the precursor material.

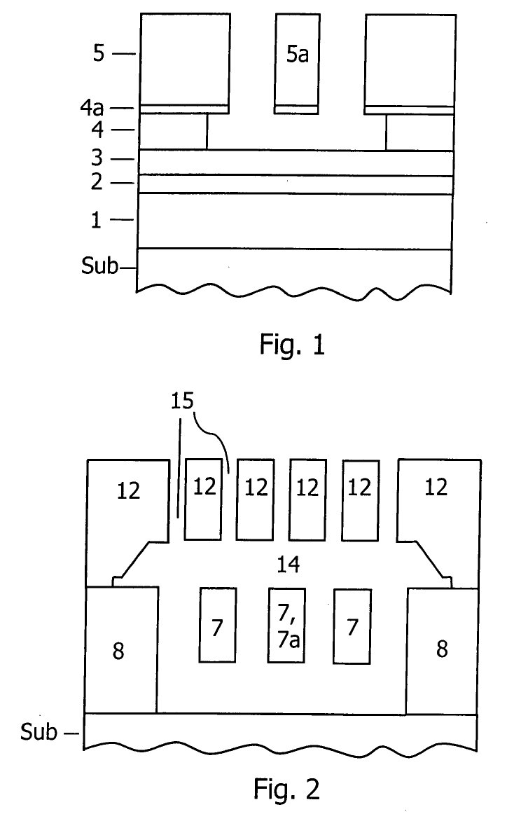

The first exemplary embodiment describes how deposition is controlled by a change in the physical state of the CO₂ fluid. FIGS. 1 and 2 depict, each in cross section, two examples of micromechanical structures on a substrate Sub, onto which deposition of an anti-adhesion layer can be carried out.

FIG. 1 shows a substrate Sub on which are provided, in succession, a first insulation layer 1, a conductive layer 2, a second insulation layer 3, a sacrificial layer 4, a protective layer 4a, and a structured layer 5 having a micromechanical structure 5a. FIG. 2, on the other hand, shows, on a substrate Sub, sensor elements 7 having a movable micromechanical structure 7a inside a cavity 14. The cavity is physically delimited by the adjacent surfaces of substrate Sub, of support structures 8, and of an encapsulating layer 12. After the manufacture and encapsulation of sensor elements 7, made typically of silicon, access channels 15 (called perforation holes) are subsequently structured into encapsulating layer 12. Optionally, the holes can already be present in encapsulating layer 12, so that subsequent structuring is not necessary. Such perforation holes are often provided so that the atmosphere in cavity 14 can later be evacuated, and then closed off again. These perforation holes can be used for the method according to the example embodiment of the present invention in the context of delivery of the CO₂ fluid. According to the example embodiment of the present invention, supercritical CO₂ fluid is used as a transport and dissolution medium. Before delivery of the CO₂ fluid to the micromechanical structures, the material to be deposited is mixed into the CO₂ fluid.

If the material to be deposited is made up of nonpolar molecules, the material dissolves directly in the CO₂ fluid. In the case of a material made of polar molecules that are poorly soluble in the CO₂ fluid, cosolvents or wetting agents are added to the CO₂ fluid. Examples of substances made of polar molecules are water, dimethyl sulfoxide (DMSO), acetonitrile, methanol, or phenol, whereas substances such as benzene, cyclohexane, tetrachloroethylene, or hydrocarbons are made up of nonpolar molecules. With cosolvents and in so-called microemulsions, made up of CO₂ plus water plus wetting agent, even highly polar molecules and ions can be dissolved and transported in large volume proportions in supercritical CO₂ fluid. The addition of cosolvents or wetting agents to the CO₂ makes possible a much wider spectrum of usable chemicals for the anti-adhesion layer. These wetting agents are also referred to as surfactants (=surface active agents). The surfactant AOT (sodium dioctylsulfosuccinate) is often used. In this context, a substantial chemical reaction such as that between chlorine and the surface to be coated is not a prerequisite for layer deposition, a certain affinity for the silicon surface on the part of the molecules to be deposited instead being sufficient.

The supercritical CO₂ fluid, with the deposition material dissolved therein, is conveyed through the access holes to the micromechanical structures. Raising the temperature or pressure of the CO₂ fluid above the critical temperature or critical pressure yields a CO₂ fluid having a negligibly low surface tension and improved dissolution properties in terms of the molecules to be deposited. This applies for the case both with and without a cosolvent. Because of its low surface tension, this mixture can be transported into even the smallest structures having the most pronounced topographies and the narrowest accesses.

Deposition of the material in the CO₂ fluid is achieved by decreasing the temperature or pressure of the fluid. Decreasing the pressure reduces the solubility of the material in the CO₂ fluid, i.e., the quantity of material that the fluid can dissolve decreases. The result is deposition of the material from the CO₂ fluid, thus causing formation of the anti-adhesion layer on the surface of the micromechanical structures.

Precise control of the pressure and temperature allows deposition to occur slowly or abruptly. The solubility of the material or precursor material in the supercritical CO₂ fluid is lowered, by a controlled decrease in pressure and/or temperature, only until the corresponding deposition quantity or layer thickness is achieved. Alternatively, the decrease in pressure and/or temperature can be accomplished until the CO₂ fluid is converted from the supercritical to the liquid phase. Deposition then occurs abruptly upon direct passage through the phase boundary. In both cases, therefore, in contrast to a gas-phase process, deposition begins not with the presence of the reaction medium, but at a point in time at which sufficient reaction medium is already present at all relevant locations that are to be coated. The exact moment of deposition can thus be determined by adjusting the pressure and temperature.

The second exemplary embodiment of the method according to the present invention describes how a transition to the liquid state of the CO₂ fluid can be dispensed with as initiator of a deposition reaction, since provision can be made for a surface reaction, directly from the supercritical state, between the surface and the precursor material.

A precursor material, with which a “self-assembled monolayer” (SAM) can be formed on surfaces of the structures, is added to the supercritical CO₂ fluid before it is delivered to the micromechanical structures. The precursor material is made up of molecules having a functional group that reacts with the silicon surface. This encompasses, for example, all organic chlorosilanes, including perfluoroalkylchlorosilanes and dimethyldichlorosilanes, but also so-called dynasilanes, which constitute chlorine-free silanes, siloxanes, or siloxenes.

After delivery of the supercritical CO₂ fluid to the structures, the chlorosilane group or functional group of the precursor material interacts with OH groups on the Si surface. Attachment of the precursor material molecules to the Si surface via the OH groups occurs for as long as they encounter such free OH groups. A process of this kind is self-stopping; i.e., when all the open OH binding locations are occupied, deposition automatically ends. This guarantees the formation of exactly one monolayer of the deposition material, of a homogeneous and accurately defined thickness, over all the structures, relatively independently of process duration and exact process conditions. This monolayer deposition mechanism also functions directly from the supercritical phase of the CO₂ fluid, so that, as already mentioned, there is no longer a need for a phase transition from a supercritical CO₂ fluid to a normal liquid CO₂ fluid as initiator of the deposition reaction.

Advantageously, the surface reaction can be carried out on a homogeneous hydrophilized surface if, prior to delivery of the precursor material, the micromechanical structures are rinsed first with a supercritical water-containing CO₂ fluid and then with a supercritical anhydrous CO₂ fluid. This combines intensive cleaning with hydrophilization of the surfaces. The very small admixture of water molecules in the first rinsing step causes cleaning as well as saturation of the Si surface with OH groups, since the water molecules interact with the Si surface at every location accessible to the supercritical CO₂/H₂O mixture. In the second rinsing step, the water-containing CO₂ fluid is displaced by the anhydrous CO₂ fluid. Lastly, as soon as no water molecules (or only a very small and negligible quantity thereof) are present in the CO₂ fluid, the supercritical CO₂ fluid with added precursor molecules is introduced, thus displacing the pure (or almost pure) CO₂ fluid. These molecules precipitate onto the surfaces that have been highly purified by the action of supercritical CO₂ fluid and hydrophilized by the water that was previously present, forming a high-quality SAM coating. All the free OH groups are used as “docking” locations for the functional groups of the SAM precursor.

When SAM precursor material is used to form a monolayer on the surface of the structures, individual process steps such as the controlled pressure reduction are, in contrast to the first exemplifying embodiment, omitted, thus simplifying the method. A “self-organizing monolayer” can also be expected to form a more homogeneous layer.

With both exemplary embodiments, the supercritical CO₂ fluid can be delivered to the micromechanical structures in a cavity after it has been encapsulated, via access channels or perforation holes. Both embodiments are also suitable for depositing the anti-adhesion layer onto surfaces of long, narrow channels or onto structure surfaces that face toward the substrate.

1-10. (canceled)

11. A method for depositing an anti-adhesion layer onto a surface of micromechanical structures on a substrate, comprising:
delivering one of a material and a precursor material to be deposited to the structures in a dissolution and transport medium, wherein:
upon delivery, supercritical CO₂ fluid is present as the dissolution and transport medium, and
deposition of the one of the material and the precursor material is brought about by one of a change in a physical state of the CO₂ fluid and a surface reaction between the surface and the precursor material.

12. The method as recited in claim 11, wherein the change in physical state is achieved by a decrease in at least one of a temperature and a pressure of the CO₂ fluid.

13. The method as recited in claim 12, wherein, as a result of the decrease in at least one of the temperature and the pressure, the CO₂ fluid is converted into a liquid phase.

14. The method as recited in claim 12, wherein, as a result of the decrease in at least one of the temperature and the pressure, a solubility of the one of the material and the precursor material in the CO₂ fluid is reduced.

15. The method as recited in claim 11, wherein the surface reaction is a reaction between the surface and a functional group of the precursor material, thereby bringing about a deposition of a monolayer corresponding to a self-assembled monolayer, SAM, on the surface.

16. The method as recited in claim 15, wherein a chlorosilane group, a siloxane group, a dynasilane group, or a siloxene group interacts, as the functional group of the precursor material, with OH groups on a silicon surface.

17. The method as recited in claim 15, wherein the surface reaction is carried out on a hydrophilized surface, the micromechanical structures being rinsed, before delivery of the precursor material, first with a supercritical water-containing CO₂ fluid and then with a supercritical anhydrous CO₂ fluid.

18. The method as recited in claim 11, wherein one of a cosolvent and a wetting agent including sodium dioctylsulfosuccinate (AOT) is added to the CO₂ fluid.

19. The method as recited in claim 11, wherein the CO₂ fluid is delivered to the micromechanical structures in a cavity after encapsulation thereof, via one of access channels and perforation holes.

20. The method as recited in claim 11, wherein the anti-adhesion layer is deposited onto one of surfaces of long, narrow channels and surfaces, facing toward the substrate of the micromechanical structures.
